(19) United States
(12) Patent Application Publication
(10) Pub. No.: US 2016/0091041 A1
(43) Pub. Date: Mar. 31, 2016

(54) MATERIAL WITH VARIABLE HEIGHT BARBS

(71) Applicant: Ray ARBESMAN, Toronto (CA)

(72) Inventor: Ray ARBESMAN, Toronto (CA)

(21) Appl. No.: 14/590,444

(22) Filed: Jan. 6, 2015

(30) Foreign Application Priority Data
Sep. 26, 2014 (CA) 2865386

(51) Int. Cl. F16D 69/04; F16D 65/092

(52) U.S. Cl. CPC F16D 69/04; F16D 65/092; F16D 2069/0441

(57) ABSTRACT

The present invention is a differentially textured material made from a workpiece made of a ductile material with a substantially flat face on which are raised rows of integral and generally pointed barbs. Each barb has a height above the substantially flat face of the ductile material from which the barbs are gouged out. The heights of the barbs vary substantially. The material may be steel and in the form of a sheet. The differentially textured material is particularly well suited for manufacturing disc brake backing plates where the barbs are used to bond the backing plate to friction material. The present invention also includes methods for making such differentially textured material.

### CROSS-REFERENCE TO RELATED APPLICATIONS

This application claims benefit of Canadian patent application number 2,865,386, filed Sep. 26, 2014, which is herein incorporated by reference.

### FIELD OF THE INVENTION

The present invention relates generally to textured material, and more particularly to textured material with pointed structures extending from a surface of the material.

### BACKGROUND OF THE INVENTION

Laminates are used in various applications (e.g. building materials, panels for automotive applications, large scale industrial parts). In making laminated materials, it is common to use adhesive to join the laminae. However, adhesives have many known deficiencies. They are expensive, messy and emit noxious fumes. Many typical adhesives used for laminating heterogeneous materials are also prone to failure or shattering/cracking under various stresses (temperature, bending, cutting). Further, adhesives are undesirable from an environmental point of view as they foul the underlying materials and prevent recycling or reclamation of the laminae. It would be desirable to avoid the use of adhesive without compromising the strength of the laminate.

Vehicles with disc brake pads use friction to stop. Such disc brake pads are a laminate with one lamina being a stiff backing plate, usually of steel, and second lamina being a hard-wearing friction material. Such brake pads fit into a stationary caliper that hydraulically clamps them with enormous force against a rotating disc (“rotor”) whereby the vehicle is slowed by the resulting friction. The high temperatures and pressures wears away (ablates) the friction material over time.

The friction generates a very high shear force between the friction material and the plate. It follows that the means of attachment of the mineral-based friction material to the metal-based plate is extremely important for safe and reliable braking. Similar concerns exist for laminates subject to shear forces generally.

The friction material generally begins as a powder comprising a complex mixture of minerals, fibres and binders that is hot-compressed onto the plate. Adhesives and/or holes, hooks, weldments and other ant-shear features in, on or through the plate, are conventionally used to securely attach the friction material to the plate.

### SUMMARY OF THE INVENTION

In a first aspect, the present invention provides a differentially textured workpiece comprising a workpiece made of a ductile material with a substantially flat face. Multiple rows of integral raised barbs are on the flat face. A first group of the barbs are at least 10% higher, relative to the substantially flat face, than a second group of barbs. The first group of barbs includes at least 10% of the barbs, and the second group of barbs includes at least 10% of the barbs.

Preferably, the first group of barbs includes at least 25% of the barbs, and the second group of barbs includes at least 25% of the barbs.

Preferably, the barbs are curved. The barbs in the second group of barbs may be bent so that they are not straight and not deformed. Alternatively, the barbs in the second group of barbs may be deformed so that they have a flattened distal end.

Preferably, the height variation of the barbs forms a regular pattern.

The ductile material is preferably steel, and the base workpiece may be a sheet of steel.

The base workpiece may be a disc brake backing plate, and the barbs may be configured to receive and retain friction material.

Each barb in the first group of the barbs may be at least 25% higher than each barb in the second group of barbs. Each barb in the first group of barbs may be at least 50% higher than each barb in the second group of barbs.

The first group of barbs may include at least 40% of the barbs, and the second group of barbs may also include at least 40% of the barbs. Also, each barb in the first group of barbs may be at least 25% higher than each barb in the second group of barbs.

In a second aspect, the invention provides a brake pad including a differentially textured steel workpiece and a friction element. The steel workpiece is configured to be a disc brake backing plate and has a substantially flat face with rows of integral raised barbs. The heights of the barbs above the substantially flat face vary substantially. The friction material is adhered to the textured face of the differentially textured workpiece to form a brake pad. Preferably a first group of barbs are at least 10% higher than a second group of barbs, the first group of barbs includes at least 10% of the barbs, and the second group of barbs includes at least 10% of the barbs.

In a third aspect, the invention provides a method of making a differentially textured workpiece. The method is applied to a base workpiece made of ductile material having a flat face. The flat face of the base workpiece is first textured with rows of integral raised barbs having substantially the same height relative to the flat face. Then, a second group of barbs is reshaped to substantially reduce the height of each barb in the second group of barbs relative to each barb in a first group of barbs.

In this method, the reshaping is preferably done so that the height variation of the barbs forms a regular pattern.

The step of texturing the flat face of the base workpiece may involve gouging or planing the flat face of the base workpiece with a plurality of toothed blades so that each blade creates a row of raised barbs on the flat face of the base workpiece to texture the base workpiece. The toothed blades may have cutting tip geometries configured to cut grooves in the flat face of substantially the same length, thereby creating barbs of substantially the same height.

In this method, the barbs formed by texturing the flat face of the base workpiece are preferably curved. The barbs in the second group of barbs may be bent so that they are not straight and not deformed. Alternatively, the barbs in the second group of barbs may be deformed so that they each have a flattened distal end.

The step of reshaping the second group of barbs may be performed by passing a lobed roller over the textured face, thereby causing the lobes to bend each barb in the second group of barbs substantially more than any barbs in the first group of barbs are bent. It may be the case that none of the barbs in the first group of barbs are bent (or deformed) by the lobed roller.

The step of reshaping the second group of barbs may be performed by pressing the second group of barbs downward using a fluted plate in a stamping press to reduce the height of each barb in the second group of barbs.

In this method, the ductile material may be steel. The base workpiece may be a sheet of steel, and the barbs may be configured to receive and retain friction material.

In this method, the base workpiece may be a disc brake backing plate.

In this method, at least 25% of the barbs may be included in the second group of barbs and those barbs may each be at least 10% lower than each of the barbs in the first plurality of barbs. At least 25% of the barbs may be included in the second group of barbs and those barbs may each be at least 25% lower than each of the barbs in the first plurality of barbs.

In this method, the base workpiece may be configured to be a disc brake backing plate and the barbs may be configured to receive and retain friction material.

In a fourth aspect, the invention provides another method of making a differentially textured workpiece. The method is applied to a base workpiece made of ductile material having a flat face. The flat face of the base workpiece is first gouged or planed with a plurality of toothed blades, each knife cutting the face to create a row of raised barbs thereby texturing the workpiece. The toothed blades have different cutting tip geometries configured to cut grooves in the substantially flat face of varying lengths thereby creating barbs of varying heights. In this method, at least 25% of the barbs may be included in the second group of barbs and those barbs may each be at least 10% lower than each of the barbs in the first plurality of barbs. The blades may be configured to cause the height variation of the barbs to form a regular pattern.

### BRIEF DESCRIPTION OF THE DRAWINGS

FIG. 1 shows a perspective of a portion of a disc brake backing plate with two representative pointed barbs of different heights that have been raised from grooves cut by the tip of a toothed blade, each barb being angled slightly to one side relative to the grooves.

FIG. 2 shows an end view of a single row of barbs having varying heights and hooked to the left and right.

FIG. 2a is perspective of rows of barbs and the grooves from which they are raised.

FIG. 3 is a top view of a portion of a brake plate showing grooves of different lengths and their respective barbs having varying heights.

FIG. 4 shows the same portion of a brake plate of as in FIG. 3 but where all barbs were initially created to have the same height, after which some were clinched, bent or deformed to a lower height.

FIG. 5 shows how the height of some barbs can be modified by the use of a fluted plate (end view) that is pressed down on the barbs.

FIG. 6 shows another method of changing the height of some of the barbs by the use of a lobed roller that contacts only some barbs and deforms or reshapes them by pressing them down.

FIG. 6a is an end view of the roller shown in FIG. 6.

FIG. 6b shows another method of changing the height of some of the barbs by the use of a roller, shown in an end view, with variable shape lobes or rolls including a V-shaped roll.

FIG. 7 shows how brake friction material breaks off a prior art backing plate when subjected to sufficient shear force. The line of fracture is uneven and in some places descends below the barb tips, leaving them visible and thus providing indication of reduced retention at those locations.

FIG. 8 shows how multi-height barbs modify the line of fracture to be above the barb tips which remain below the fracture line and thus provide indication that the friction element is retained more evenly across the entire plate surface.

FIG. 9 shows a perspective of a portion of a disc brake backing plate with one pointed barb and one deformed barb having different heights.

FIG. 10 is a side view showing a plate poised above a pointed barb.

FIG. 10a is a side view showing the plate of FIG. 10 deforming the pointed barb of FIG. 10 to form a flattened head.

FIG. 11 shows a perspective of a portion of a disc brake backing plate with two representative pointed barbs of different heights that have been raised from grooves cut by the tip of a toothed blade.

FIG. 12 is a side view showing a blade with alternating cutting tip geometries gouging barbs with differing heights from a plate.

FIG. 13 is a photograph of two conventionally barbed prior art backing plates that have had the friction pad sheared off, indicating areas of poor friction retention where the barbs are exposed.

FIG. 14 is a photograph of a barbed plate and sheared off friction pad of the instant invention where all the barbs remain fully below the fracture surface, demonstrating enhanced retention.

### DETAILED DESCRIPTION

Barbs are generally curved and pointed structures, which may be relatively sharp, that can be added to ductile materials by, for example, using blades with multiple teeth that are made to travel from opposite directions whereby the teeth gouge (or cut or plane or impact) a flat face of the ductile material, cutting to a shallow depth and for a short distance. In this way a short, shallow (non-piercing) tapered groove is ploughed, resulting in an un-severed projection (the barb) being raised at the end of each groove. Such barbs are generally formed on a flat face of a base workpiece, such as on one side of a sheet of steel.

The term “substantially flat face” is intended to describe the face before and after the integral barbs have been raised from a completely flat face since the grooves are relatively shallow and the remainder of the face remains completely flat.

The term “base workpiece” as used herein refers a piece of ductile material, such as sheet of steel, that is used to form a textured workpiece.

The term “barb” as used herein refers to any type of nail-like or pin-like structure, or curved or hooked structure or protrusion, raised from a surface of a workpiece by carving, gouging, planing or scraping its surface, such as is described in Canadian patent numbers 1,330,521, 1,337,622, and 2,127,339, which are incorporated herein by reference. Barbs may be straight and substantially perpendicular to the face from which they are raised, or may be curved or bent to varying degrees. By “bent” it is meant that the barb is not straight (i.e. the bending referred to is not relative to the face the barb was raised from). While curved barbs are preferred for use in making disc brake backing plates to help retain the friction element made of friction material, embodiments with relatively straight barbs extending substantially perpendicularly from the flat surface of the workpiece may be preferable, for example, where a hard solid material is being attached to the textured surface to facilitate the barbs piercing into the hard material. In some embodiments, the barbs may be angled relative to the flat surface of the workpiece while still being straight, although such embodiments are not preferred.

In prior art backing plate manufacture, the “forest” of hook-like barbs on a textured surface are all of equal height. Friction powder is moulded onto the plate by compression and heated until cured to form a friction element. When the resulting disc brake pad is then subjected to sufficient shear force to fracture or cleave the hardened friction material from the plate, a wavy fracture surface results. Some wave “troughs” descend into the barb zone leaving patchy friction remnants and exposed barbs indicating less than desirable attachment strength. For use with friction material it is preferred that the barbs be curved, or hook shaped, so that portions of each barb are above friction material when it hardens, thereby helping to retain the friction material on the backing plate (“above” being in the context of the substantially flat textured face of the plate being horizontal with the textured face facing upward).

In the present invention, raised, curved hook-like barbs are also generally used for friction attachment but the barbs' heights are made to vary substantially across the plate. This unexpectedly creates a more planar fracture surface with an even layer of friction material remaining on the plate over the barbs, a very desirable result.

The “height” of a barb is the perpendicular distance from a substantially flat face of the textured workpiece to the point on the barb furthest from the flat face. For a substantially perpendicular barb, the height of the barb is approximately equal to its length. In contrast, for a curved or hooked barb the height of the barb is less than its length.

By “vary substantially”, it is meant that the tallest barbs are higher than the shortest barbs by more than a substantial height differential percentage, such as 10%, 20%, 30%, 40%, 50% or even 75% to 100% or more. It is further preferred than a substantial total percentage of the barbs exhibit such height differentials, so that, for example, the heights of a certain percentage of the barbs exceed the heights of another certain percentage (or that same percentage) of the barbs by at least a substantial height differential percentage, where a substantial height differential percentage may be, for example, 10%, 20%, 25%, 30%, 40%, 45% or close to 50%. In an ideal case, for example, 50% of the barbs may have a height that is about 50% to 100% greater than the height of the other 50% of the barbs, where the heights of all the barbs in each half are equal.

Of course, there is no need for the substantial height differential percentage to be the same as percentage of barbs exhibiting that height differential. For example, for some embodiments, the substantial height differential percentage may be 10% and it may be the case that 50% of the barbs exhibit this height differential relative to the other 50%. In other embodiments, for example, the substantial height differential percentage may be 20% and it may be the case that 25% of the barbs exhibit this height differential relative to the other 75%, or with respect to only 50% or 25% of the other barbs. Although generally not preferred, the substantial height differential percentage may be less 10%.

A secondary benefit is that the taller barbs protect the shorter barbs from damage during manufacturing, handling, tumble-washing, packaging and shipping. The protected barbs retain their sharp-edged characteristics which further helps to retain the friction material.

One method of making such unequal height barbs is by using toothed blades having different cutting tip geometries. Tooth tips that are higher up on the blade will enter the plate later than lower tips resulting in longer and shorter grooves with longer and shorter barbs. In practice, tips on one blade can be at different heights, or, each blade can have tip heights different from other blades. Tip heights can also vary along the length of each blade.

FIG. 12 shows a toothed blade 34 with alternating teeth 31, 31a, where half of the teeth 31 are longer, having a height 30a, and the other half of the teeth are shorter, having a smaller height 30b. The toothed blade 34 is shown in FIG. 12 gouging five barbs 32, 33 of alternating heights 30b, 30a. The height of each barb is constrained by the height of the tooth cutting it, so that the barbs 32 cut with the shorter teeth 31a have a lower height 30b, than those barbs 33 cut with the longer teeth 31, which have a greater height 30a. Between the cutting portions of the teeth 31, 31a, the blades are arcuate 30a so that each barb is formed with a curved or hook shape.

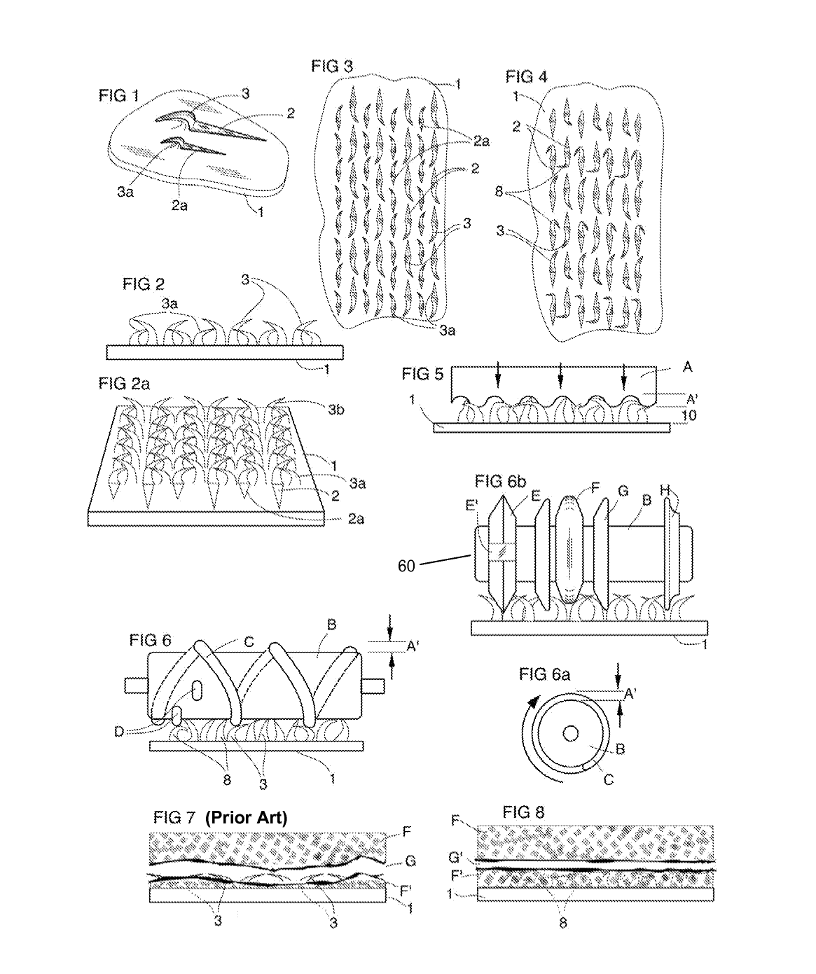

A second and preferred method is to make all the barbs of one height (or substantially the same heights), for example, using toothed blades with cutting tip geometries configured to cut grooves in a face of a base workpiece of substantially the same lengths thereby creating barbs of substantially the same heights, and then bend or deform some (a subset comprising a plurality) of the barbs (the “reshaped barbs”) to a lower height. It is preferred that the reshaped barbs be bent but still pointed, as shown, for example, in FIGS. 1 and 2, so they are not straight and so that they are not deformed and remain pointed (although some of them may in fact be deformed so they are no longer pointed). By not being deformed, it is meant that the length of the reshaped barb remains substantially the same as before reshaping, and the reshaped barb remains generally pointed, but the height is reduced.

In FIG. 1 backing plate 1 has tapered grooves 2, 2a carved or ploughed into the surface of plate 1 so as to raise unsevered barbs 3, 3a. Groove 2 is longer that groove 2a, resulting in a taller barb 3 compared to barb 3a. Groove 2a is shorter resulting in a shorter barb 3a. Barbs 3 and 3a have a hook or curled shape, which can be beneficial to allow the powder friction material F to flow under the barbs, whereafter it cures hard and cannot easily be separated from the textured backing plate. The barbs in FIG. 1 are slightly angled to one side relative to the groove. FIG. 11 shows a similar portion of a backing plate 1 with tapered grooves 2, 2a carved or ploughed into the surface of plate 1 so as to raise unsevered barbs 32, 33. Groove 2a is shorter resulting in a shorter barb 32. Barbs 32 and 33 have a hook or curled shape and are raised straight ahead relative to the grooves.

FIG. 2 shows an end view of a row of such barbs 3, 3a rising from plate 1. In FIG. 2a the perspective shows how barbs 3, 3a are formed in rows on plate 1, with alternating rows of longer and shorter barbs.

In the top view of FIG. 3, the row formation of the dual height barbs 3, 3a is depicted. That they remain attached to the end of their respective grooves 2, 2a is also shown. Also shown is how adjacent rows of barbs 3, 3a are created from opposite ends (from top, from bottom) and how they can be made to curve or hook left and right. In this embodiment, every different height of barb requires a different tool design (e.g. a different cutting tip geometry) to make it.

In a preferred embodiment, the top view in FIG. 4 shows equal height barbs made from equal length grooves 2 all cut by a single tool design (e.g. using toothed blades having similar cutting tip geometries). Some barbs are then bent or deformed to a shorter height, designated herein as reshaped barbs 8. Thus the desired mixture of tall and short barbs of different shapes and forms is present on the same plate 1, all made initially with a single tool design.

FIG. 5 shows one way in which barbs 3 can be made into reshaped barbs 8 in a stamping press with fluted plate A, having grooves with a depth A′. The plate A can be used angularly across the rows of barbs to create a preferred random pattern of barbs 3 and reshaped barbs 8. Flutes milled at different angles and lengths can also be used to randomize barb shapes. A fluted plate may reduce the heights of a subset or even all of the barbs, but will result in a significant percentage of the reshaped barbs having heights that are significantly less than another significant percentage of the reshaped barbs, even if the heights of all the barbs are reduced to some degree.

FIGS. 6 and 6a show a preferred method of reshaping barbs with a roller B having raised lobes C. FIG. 6a shows an end view of the roller. FIG. 6 shows a front view with plate 1 having reshaped barbs 8 having passed beneath the roller B. Roller B has lobes C of height A′. The lobe C in this embodiment has a spiral form so that randomly located barbs 3 are bent into reshaped barbs 8. Many other barb formers can be put onto rollers such as protrusions D.

In a more preferred embodiment one or more rollers may employ one or more a “V” shaped lobe or roll arranged to travel between the rows of barbs pushing them aside to reform them and create lower height barbs. Multiple lobes/rolls and spacers may be arranged so as to only deform alternate rows or selected rows. FIG. 6b shows a preferred method of reshaping barbs using such a roller 60 with shaped lobes that are spaced apart on a drive shaft B in accordance with the spacing of rows of barbs so as to bend some of the barbs them aside (to the left and/or right) thereby lowering their height. The barbs are initially hooked or curved so that they have substantially the same height as each other. Lobes E, F, G, and H are spaced and shaped as required with single or double-sided bevels and/or radiuses. For example lobe E has a V-shaped bending portion. As the barbs pass under the lobes those barbs that are contacted by the lobes are spread apart by bending them to either side, which lowers their height below the height of the untouched rows of barbs. In the depicted embodiment, lobe E also has a circumferential gap E′ so that it will only bend some barbs. Various combinations of shapes of lobes and spacing between lobes may be employed in forming different rollers.

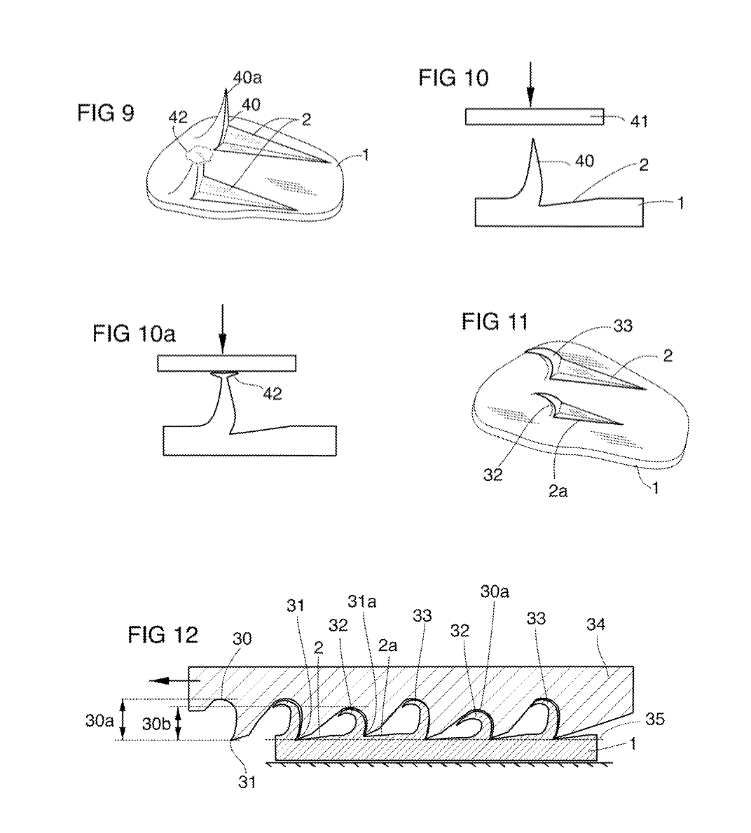

In another embodiment, some of the barbs may be deformed to form a flattened head, similar to the head of a nail. FIG. 9 shows a portion of a disk backing plate 1 with one barb 40 having a pointed distal end 40a, and a second barb with a lower height having a flattened distal end 42 that is like the head of a nail. In this embodiment, the barbs are first formed by cutting or gouging the plate to form pointed barbs, all of substantially the same height, and preferably all substantially perpendicular to the face of the plate. Then some of the barbs (for example half of them) are deformed to form the flattened distal end and lower the height of the deformed barbs relative to the undeformed barbs. This may be done as shown in FIGS. 10 and 10a by pressing a plate 41 down on some of the pointed barbs 40, to create a flattened distal end 42.

FIGS. 7 and 8 show a disc brake pad that has been tested to failure by a shear force machine (not shown). Friction material F has fractured leaving complementary wavy surfaces on the upper and bottom portions. The fracture zone is depicted by the letter G. In FIG. 7 of the prior art, barbs 3 are exposed in gap G with little friction remaining thereabout. A wavy, uneven layer of friction material F′ remains attached to plate 1 but some wave troughs have descended into the barb zone.

In FIG. 8 the instant invention is shown to cause the shearing fracture zone to be more planar in form (not wavy) and that the reshaped barbs 8 remain beneath friction F′, thus indicating superior retention of the friction material which, in turn, provides a safer disc brake pad.

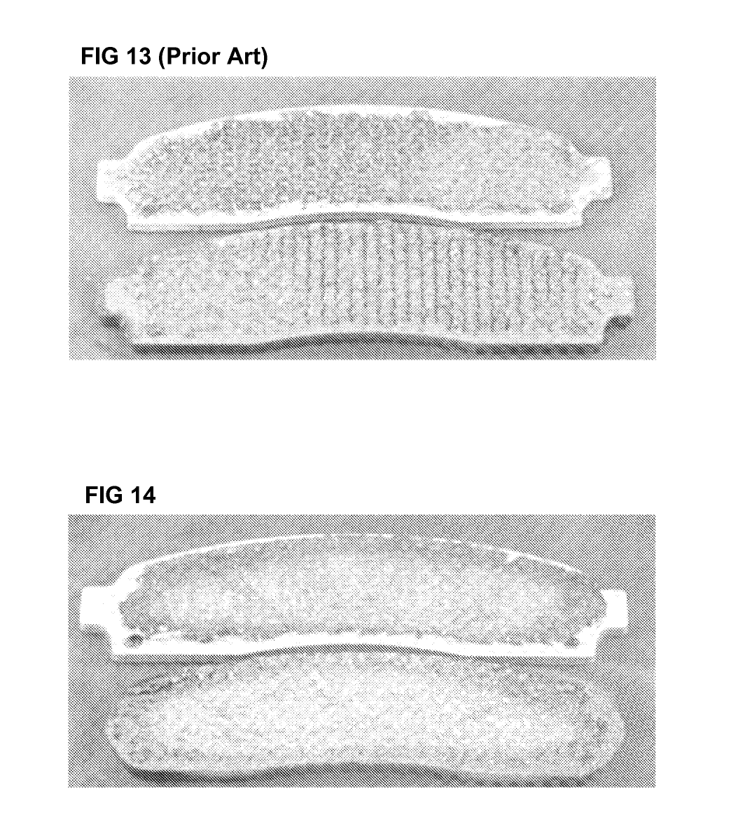

Evidence of the advantage of the present invention can be seen in FIGS. 9 and 10, where FIG. 13 shows two actual prior art disc brake pads that have been shear-broken. Clearly visible is the wavy shear zone and the exposed barbs with little friction material remaining.

FIG. 14 shows the result of using the instant invention on an actual disc brake pad. Above is the plate and below is the sheared off friction pad. A smoother fracture zone can be seen. As well, one cannot see any exposed barbs. Rather, the barbs remain fully covered in friction material, demonstrating superior friction material retention. This test evaluation was carried out on numerous production samples of brake pads and they all showed the same improved friction material retention.

Various ductile materials can be used to create such differentially textured workpieces. Although preferred embodiments are made from steel sheeting or stampings, the processes described herein to produce differentially textured workpieces can be made to work on various harder plastics (Shore hardness of approximately D55 and up) and other materials in a range of widths and thicknesses. The workpiece can also be cooled or heated prior to impacting in order to make it more ductile or otherwise amenable to the texturing operation. For example, soft and rubbery materials (including those below the suggested Shore hardness of D55) may be cooled or frozen to apply this process.

It is preferred that heights of the barbs in the differentially textured material form a regular pattern. For example, in a simple example, all the barbs in every other row may be one height, and all the barbs in the other rows a second height (for example 25% lower). The methods of forming the differentially textured material described above will naturally produce such regular height variation patterns.

Preferably, rows of barbs on the face of a workpiece are formed substantially without gaps along the length of the workpiece, such as a sheet of steel. Various patterns, arrangements, densities and dimensions of projections are possible. In one embodiment, each of the higher barbs has a finished height of less than 2.5 mm (0.1 inches). The barb dimensions may be based on a tiered scale of barb grades for different applications, such as 1.8 mm (0.07 inches), 1.5 mm (0.06 inches), 1.15 mm (0.045 inches) and 0.75 mm (0.03 inches). Preferably, in this embodiment, each barb has a finished thickness at its base of less than 0.050″, and more preferably, less than 0.040″. In this embodiment where the workpiece is a sheet of steel, each of the higher barbs preferably has a finished height between about 150% to about 300% of the thickness of the sheeting. Preferably, in this embodiment, the density of barbs on the sheeting is between approximately 30-200 barbs per square inch, such as approximately 6 barbs per square cm (40 barbs per square inch) for workpieces where the taller barbs are at least 1.5 mm (0.06 inches) high, 12 barbs per square cm (80 barbs per square inch) for workpieces where the taller barbs are at least 1.15 mm (0.045 inches) high, or 30 barbs per square cm (190 barbs per square inch) for workpieces where the taller barbs are at least 0.75 mm (0.03 inches) high. Nonetheless, a great variety of dimensions and geometries of barbs are possible. Further, the barbs need not be provided in precisely matching rows over the entire material, but may be formed in zones or patterns to suit a particular application.

The abbreviation mm as used herein refers to millimetres (or in the US, “millimeters”). The abbreviation cm as used herein refers to centimetres (or in the US, “centimeters”).

It should be understood that the above-described embodiments of the present invention, particularly, any “preferred” embodiments, are only examples of implementations, and merely set forth for a clear understanding of the principles of the invention. Many variations and modifications may be made to the above-described embodiment(s) of the invention as will be evident to those skilled in the art.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description and figures as a whole.

1. A disc brake backing plate comprising a ductile material with a face and a plurality of raised barbs extending integrally from the face, each barb having a height above the face, wherein a first plurality of the barbs are at least 10% higher than a second plurality of the barbs, wherein the first plurality of the barbs includes at least 10% of the barbs and the second plurality of the barbs includes at least 10% of the barbs, and wherein the barbs of the second plurality of barbs are not deformed and are hook-shaped and pointed.

2. The disc brake backing plate of claim 1, wherein the first plurality of the barbs includes at least 25% of the barbs, and the second plurality of the barbs includes at least 25% of the barbs.

3. The disc brake backing plate of claim 1, wherein the barbs of the first plurality are curved.

4. (canceled)

5. (canceled)

6. (canceled)

7. The disc brake backing plate of claim 1, wherein the height variation of the barbs forms a regular pattern.

8. The disc brake backing plate of claim 1, wherein the ductile material is steel.

9. The disc brake backing plate of claim 8, wherein the barbs are configured to receive and retain friction material.

10. The disc brake backing plate of claim 1, wherein each barb in the first plurality of the barbs is at least 25% higher than each barb in the second plurality of the barbs.

11. The disc brake backing plate of claim 10, wherein each barb in the first plurality of the barbs is at least 50% higher than each barb in the second plurality of the barbs.

12. The disc brake backing plate of claim 1, wherein the first plurality of the barbs includes at least 40% of the barbs, and the second plurality of the barbs includes at least 40% of the barbs.

13. The disc brake backing plate of claim 12, wherein each barb in the first plurality of the barbs is at least 25% higher than each barb in the second plurality of the barbs.

14. A brake pad comprising:
(a) a disc brake backing plate comprising a differentially textured steel workpiece, the steel workpiece having a substantially flat face and a plurality of raised barbs extending integrally from the flat face, each barb having a height above the substantially flat face, wherein the height of a first plurality of the barbs is greater than the height of a second plurality of the barbs, and wherein the barbs of the second plurality of barbs are not deformed and are hook-shaped and pointed; and
(b) a friction element secured to the steel workpiece via the barbs.

15. The brake pad of claim 14, wherein the first plurality of the barbs are at least 10% higher than the second plurality of the barbs, and wherein the first plurality of the barbs includes at least 10% of the barbs, and the second plurality of the barbs includes at least 10% of the barbs.

16.-27. (canceled)

28. A method of making a differentially textured workpiece, the method comprising the steps of:
(a) gouging a substantially flat face of a base workpiece of a ductile material with a first tooth of a first geometry to create a first barb having a first height above the flat face; and
b) gouging the flat face with a second tooth of a second geometry to create a second barb having a second height above the flat face that is less than the first height, wherein the second barb is not deformed and is hook-shaped and pointed.

29. The method of claim 28, further comprising repeating steps a) and b) to create a plurality of first barbs and a plurality of second barbs, wherein the plurality of second barbs includes at least 25% of a total number of barbs on the workpiece and the barbs of the plurality of second barbs are each at least 10% lower than the barbs of the plurality of first barbs.

30. The method of claim 28, further comprising repeating steps a) and b) to create a plurality of first barbs and a plurality of second barbs in a regular pattern.

31. (canceled)
